(19) United States
(12) Patent Application Publication
(10) Pub. No.: US 2021/0251440 A1
(43) Pub. Date: Aug. 19, 2021

(54) WIRELESS POWER SUPPLY AND ELECTRIC CONTROL SYSTEM FOR TOILET SEAT COVER

(71) Applicant: Purity (Xiamen) Sanitary Ware Co., Ltd., Xiamen City (CN)

(72) Inventors: JAMES WU, Taichung City (TW); ALEX WU, Taichung City (TW); CE-WEN YANG, Xiamen City (CN)

(73) Assignee: Purity (Xiamen) Sanitary Ware Co., Ltd., Xiamen City (CN)

(21) Appl. No.: 16/795,007

(22) Filed: Feb. 19, 2020

(51) Int. Cl. A47K 13/10; H02J 7/00; H02J 50/00; H02J 50/10

(52) U.S. Cl. CPC A47K 13/105; H02J 50/10; H02J 50/005; H02J 7/0045

(57) ABSTRACT

A wireless power supply and electric control system for a toilet seat cover is provided, including a seat cover assembly, an electric device, and a direct current power supply device. The seat cover assembly includes a seat and a cover controllable to move pivotally relative to the seat. When the cover is in a closed state, the cover covers the seat, while when the cover is in a lifted state, the cover doesn't cover the seat. The electric device is provided in the seat cover assembly and includes an electric control unit for transmitting electrical control signal to an electric assembly for actuating. The direct current power supply device is provided in the seat cover assembly and includes a rechargeable battery for supplying power to the electrically connected electric device. The present invention has no exposed plug or external wire for preventing users from getting an electric shock.

### BACKGROUND OF THE INVENTION

### 1. Technical Field

The present invention relates generally to a toilet seat cover, and more particularly to a wireless power supply and electric control system for a toilet seat cover.

### 2. Description of Related Art

With the advancement of technology, modern people pay much attention to the quality of life and health. For example, office workers have to maintain a sedentary posture over a long period so that many of them are suffering from hemorrhoids. Therefore, bidet toilets are more and more common in domestic toilets to facilitate users to washing their anuses after defecation.

Additionally, bidet toilets also facilitate female users to clean their intimate part to reduce the chance of urinary tract infections.

Besides, in higher latitude countries or regions, due to the cold climate, residents usually add extra cushions on the toilet seat to keep them warm. However, when flushing, the water could be splashed out of the toilet, causing the cushion to be dirty so it would be difficult to maintain hygiene. In view of this, electric heated toilet seats have been developed. With an electric heating device combined with the toilet seat, a user can sit directly on the warm toilet seat, and it's convenient for cleaning and maintaining hygiene.

Both the bidet toilet seat and the electric heated toilet seat have an exposed plug put in the socket to supply power to the toilet seat. Nevertheless, if water leaks while the toilet is being cleaned, the exposed plug or external wire may cause electric leakage which could let users get an electric shock unexpectedly and even be life-threatening.

From the above, the present toilet seats with exposed plugs or external wires still need to be improved.

### BRIEF SUMMARY OF THE INVENTION

In view of the above, the primary objective of the present invention is to provide a wireless power supply and electric control system for a toilet seat cover, which supplies power to electric devices in the toilet seat cover with a direct current power supply device rather than an exposed plug or external wire, which prevents users from getting an electric shock.

The present invention provides a wireless power supply and electric control system for a toilet seat cover, including a seat cover assembly, an electric device, and a direct current power supply device; the seat cover assembly includes a seat and a cover which is controllable to move pivotally relative to the seat so that the cover is in a closed state or a lifted state relative to the seat, wherein when the cover is in the closed state relative to the seat, the cover covers the seat, while when the cover is in the lifted state relative to the seat, the cover doesn't cover the seat so that the seat is exposed. The electric device is provided in the seat cover assembly, and includes an electric control unit and at least an electric assembly, wherein the electric control unit transmits an electrical control signal to the at least an electric assembly to actuate the at least an electric assembly. The direct current power supply device is provided in the seat cover assembly and is electrically connected to the electric device; the direct current power supply device includes at least a rechargeable battery which supplies power to the electric device for operation.

The wireless power supply and electric control system supplies power to the electric device in the toilet seat cover with the direct current power supply device rather than an exposed plug or external wire, which prevents users from getting an electric shock. Besides, using the rechargeable battery as the resource of direct current for the direct current power supply device makes the toilet seat cover beautiful and clean, which improves the quality and brings the toilet seat cover a sense of design.

### BRIEF DESCRIPTION OF THE SEVERAL VIEWS OF THE DRAWINGS

The present invention will be best understood by referring to the following detailed description of some illustrative embodiments in conjunction with the accompanying drawings, in which

FIG. 1 is a block diagram of the wireless power supply and electric control system for a toilet seat cover of the first preferred embodiment of the present invention;

FIG. 2 is a block diagram of the wireless charging system for a toilet seat cover of the first embodiment;

FIG. 3 is a block diagram of the power transmission module system for a toilet seat cover of the first embodiment;

FIG. 4 is a block diagram of the electric control system for a toilet seat cover of the first preferred embodiment;

FIG. 5 is a top view of the toilet seat cover of the first embodiment;

FIG. 6 is a partial sectional view of the toilet seat cover of the first embodiment;

FIG. 7 is another partial sectional view of the toilet seat cover of the first embodiment;

FIG. 8 is a schematic diagram showing the toilet seat cover of the first embodiment being charged in the lifted state; and

FIG. 9 is a schematic diagram showing the toilet seat cover of the second embodiment being charged in the closed state.

### DETAILED DESCRIPTION OF THE INVENTION

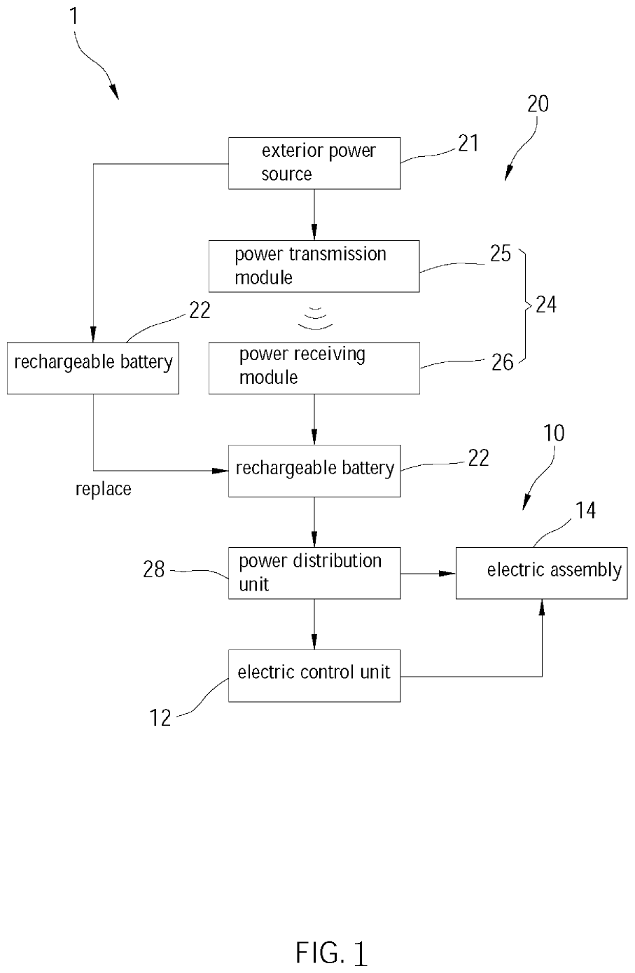

As shown in FIG. 1, a wireless power supply and electric control system for a toilet seat cover 1, the first embodiment of the present invention, includes a seat cover assembly 5, an electric device 10, and a direct current power supply device 20.

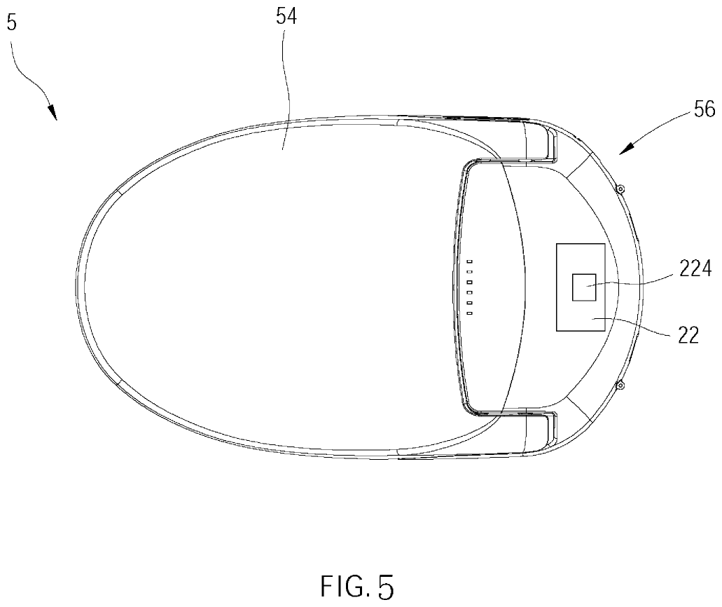

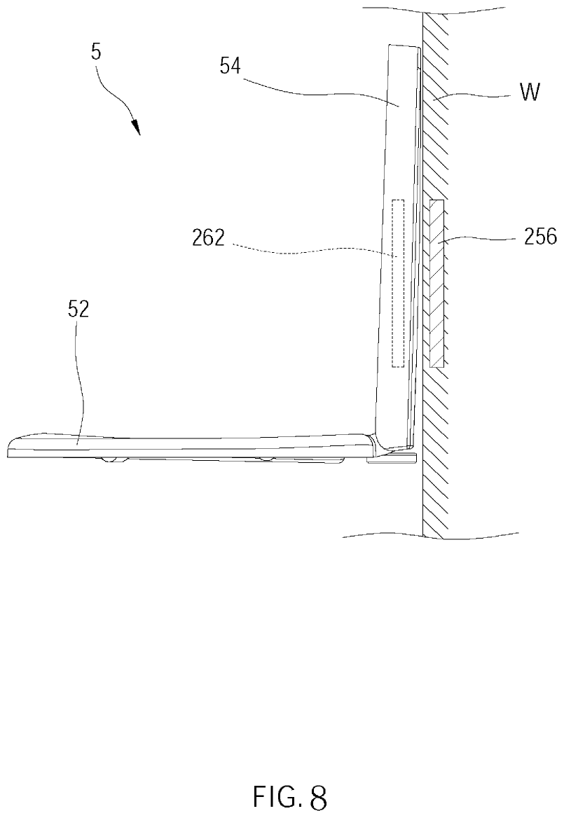

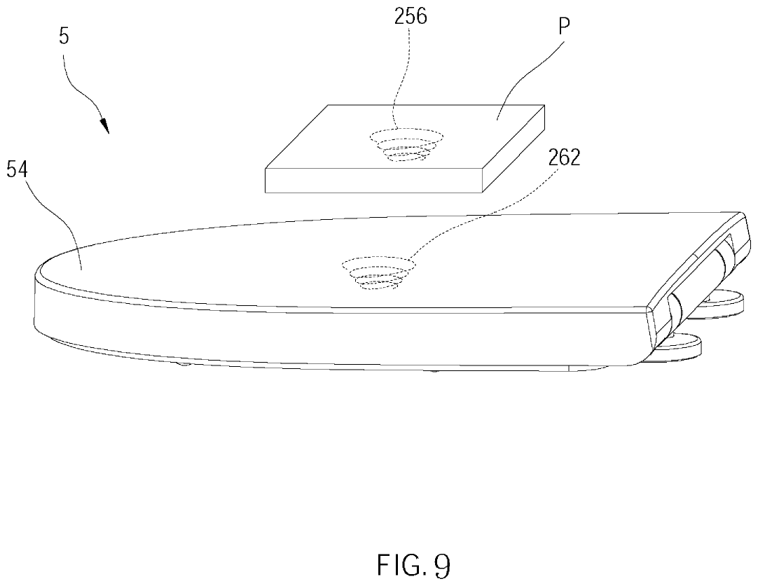

As illustrated in FIG. 5, the seat cover assembly 5 includes a seat 52 and a cover 54, wherein the cover 54 is controllable to move pivotally relative to the seat 52, so that the cover 54 can be in a closed state (as shown in FIG. 9) or a lifted state (as shown in FIG. 8) relative to the seat 52.

As illustrated in FIG. 9, when the cover 54 is in the closed state relative to the seat 52, the cover 54 covers the seat 52. As illustrated in FIG. 8, when the cover 54 is in the lifted state relative to the seat 52, the cover 54 doesn't cover the seat 52 so that the seat 52 is exposed.

The electric device 10 is provided in the seat cover assembly 5, and includes an electric control unit 12 and at least an electric assembly 14. The electric control unit 12 transmits electrical control signal to the electric assembly 14 to actuate the electric assembly 14.

The direct current power supply device 20 is provided in the seat cover assembly 5, and is electrically connected to the electric device 10. The direct current power supply device 20 includes at least a rechargeable battery 22 which supplies power to the electric device 10 for operation. In this embodiment, the rechargeable battery 22 can be fixed in the seat cover assembly 5. In this embodiment, the rechargeable battery 22 is detachably provided in the seat cover assembly 5.

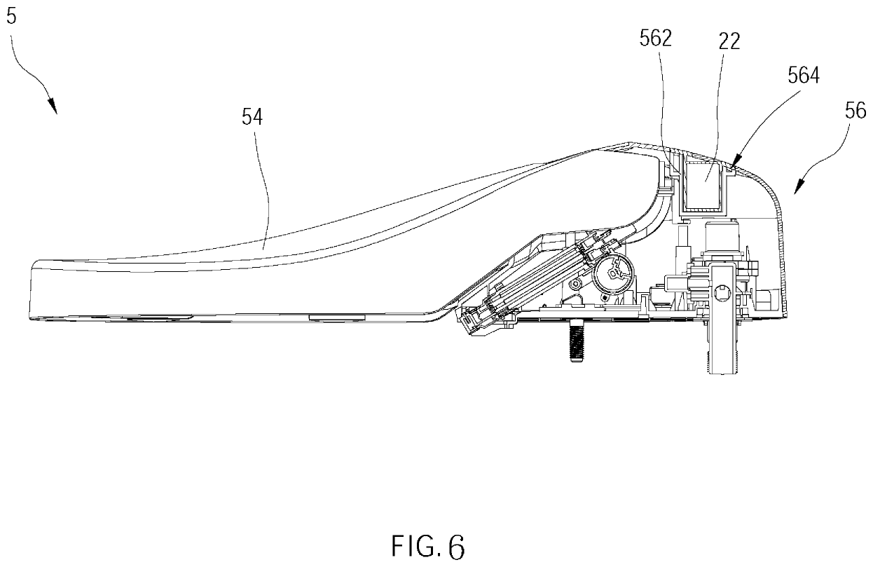

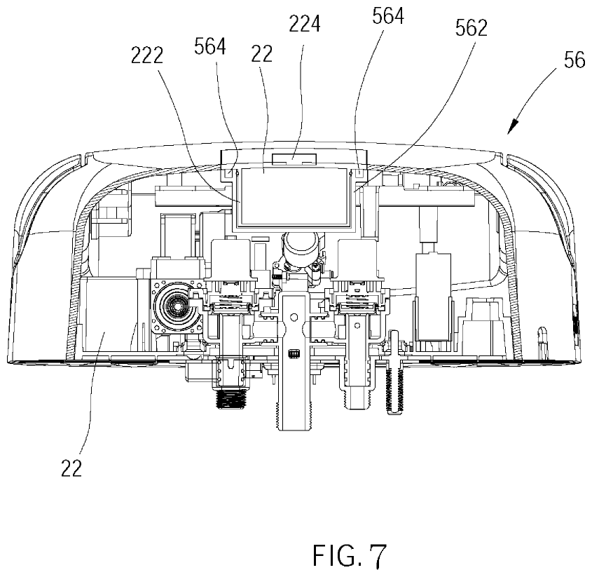

Referring to FIG. 6 and FIG. 7, FIG. 6 is a partial sectional view of the toilet seat cover of the first embodiment, while FIG. 7 is another partial sectional view of the toilet seat cover of the first embodiment. As shown in FIG. 6 and FIG. 7, the seat cover assembly 5 includes a cover main body 56, and the number of the rechargeable battery 22 is two. One of the two rechargeable batteries 22 is fixed in the cover main body 56, while the other rechargeable battery 22 is detachably provided in the cover main body 56.

In this embodiment, the cover main body 56 has a battery compartment 562 for accommodating the rechargeable battery 22, so that the rechargeable battery 22 can be detachably installed in the battery compartment 562. In this embodiment, the rechargeable battery 22 has a drawing groove 224 on the top surface thereof, which facilitates users to pull out the rechargeable battery 22 from the battery compartment 562 and replace the rechargeable battery 22. In this embodiment, the battery compartment 562 has a drainage groove 564 provided around the top edge of the battery compartment 562 to prevent water from entering the battery compartment 562, which causes electric leakage. In this embodiment, the rechargeable battery 22 includes a waterproof ring 222 provided around the outer surface thereof. When the rechargeable battery 22 is installed in the battery compartment 562, the waterproof ring 222 is sandwiched between the outer surface of the rechargeable battery 22 and the inner wall of the battery compartment 562.

As shown in FIG. 1, the direct current power supply device 20 includes a wireless charging member 24 which includes a power transmission module 25 and a power receiving module 26, wherein the power transmission module 25 and the power receiving module 26 are connected through electromagnetic signal. When the power transmission module 25 is electrically connected to an exterior power source 21, the power transmission module 25 transmits an electromagnetic signal to the power receiving module 26. The power receiving module 26 is electrically connected to the rechargeable battery 22 for charging the rechargeable battery 22. As shown in FIG. 1, the rechargeable battery 22 can also be detached from the direct current power supply device 20 and replaced. That is, when the power of the rechargeable battery 22 in the direct current power supply device 20 is low, it can be replaced by another rechargeable battery 22 that is fully-charged, so that the wireless power supply and electric control system for a toilet seat cover 1 can work normally.

As shown in FIG. 1, the direct current power supply device 20 includes a power distribution unit 28 which is electrically connected to the electric control unit 12 and the electric assembly 14 of the electric device 10 so as to supply the electric control unit 12 and the electric assembly 14 direct current.

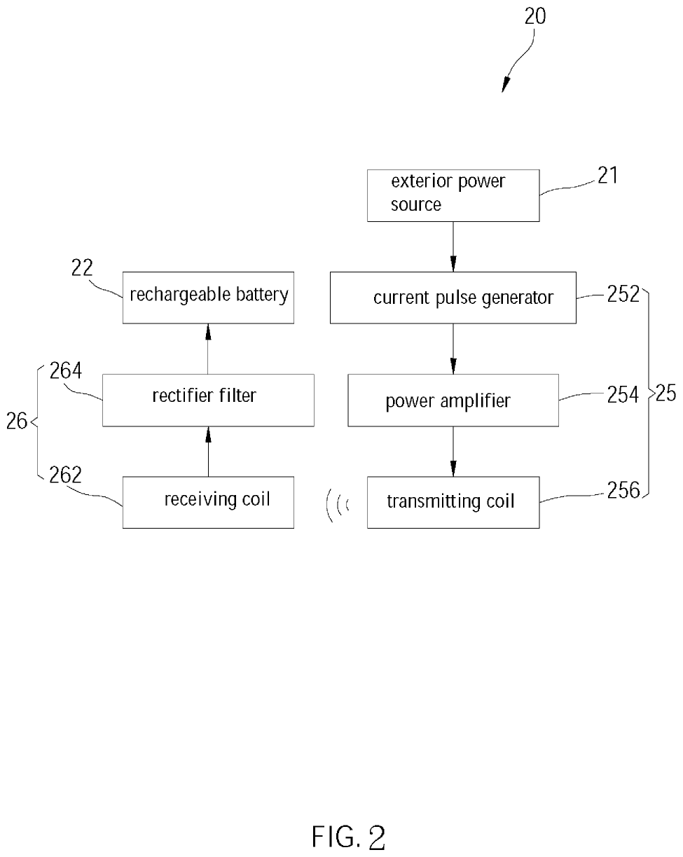

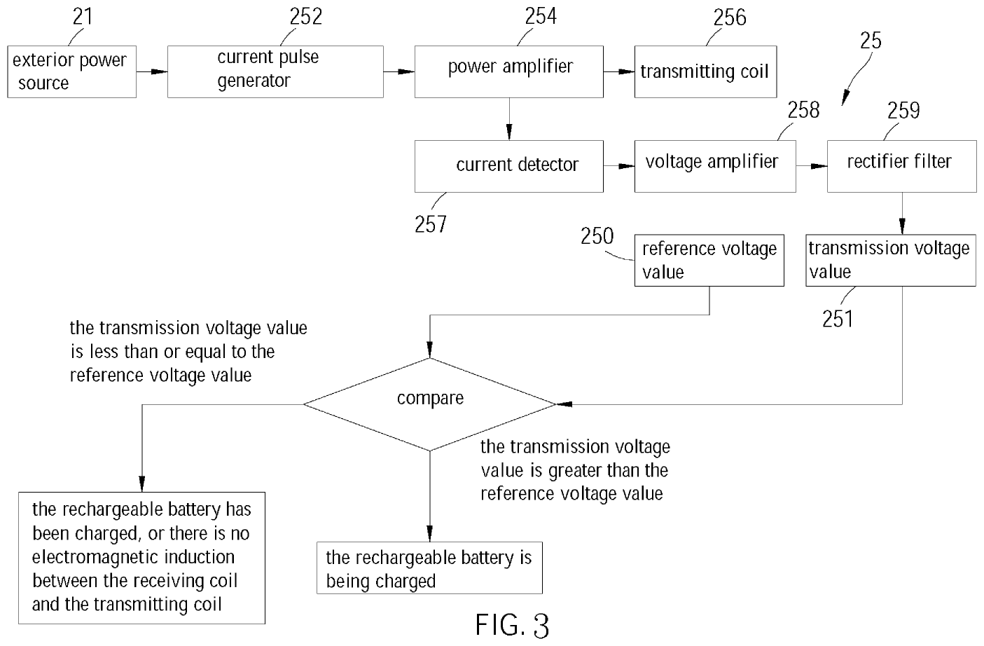

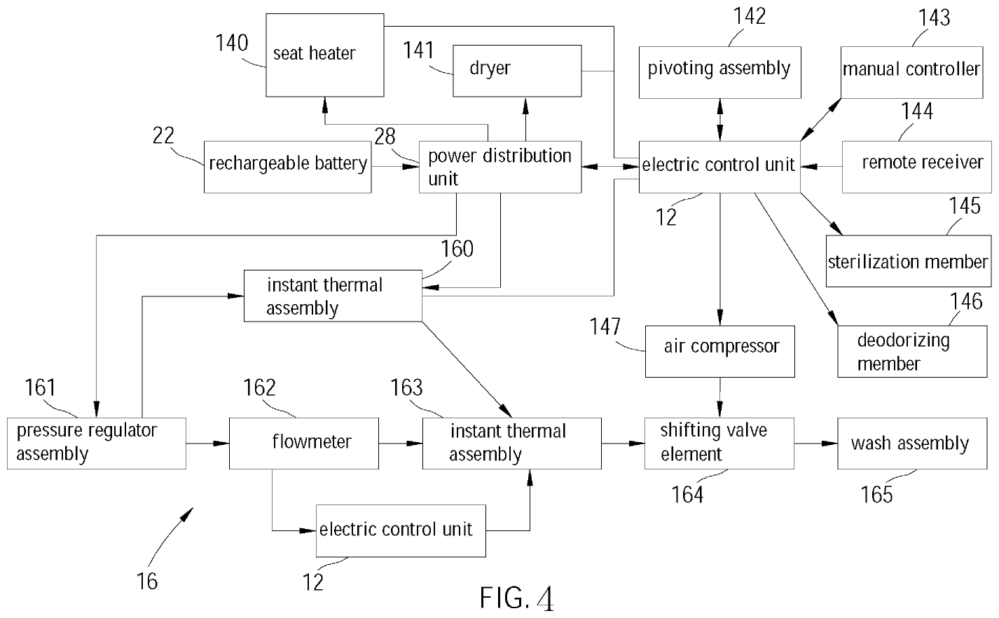

Referring to FIG. 2 to FIG. 4, FIG. 2 is a block diagram of the wireless charging system for a toilet seat cover of the first embodiment; FIG. 3 is a block diagram of the power transmission module system for a toilet seat cover of the first embodiment; FIG. 4 is a block diagram of the electric control system for a toilet seat cover of the first preferred embodiment.

As shown in FIG. 2, the power transmission module 25 includes a current pulse generator 252, a power amplifier 254, and a transmitting coil 256. During the exterior power source 21 supplies direct current to the power transmission module 25, the direct current passes through the current pulse generator 252, the power amplifier 254, and the transmitting coil 256 in sequence, which makes the transmitting coil 256 generate a magnetic field. The power receiving module 26 includes a receiving coil 262 and a rectifier filter 264. When the transmitting coil 256 generates a magnetic field, and when the receiving coil 262 approaches the transmitting coil 256, the receiving coil 262 generates induced current which passes through the rectifier filter 264 and then supplies power to the rechargeable battery 22.

In this embodiment, the transmitting coil 256 is provided in the wall W, while the receiving coil 262 is provided in the cover 54 of the seat cover assembly 5. When the cover 54 is in the lifted state relative to the seat 52, the receiving coil 262 and the transmitting coil 256 are close to each other, which makes the receiving coil 262 generate induced current to charge the rechargeable battery 22 as shown in FIG. 8.

In the second embodiment, the transmitting coil 256 is provided in a portable wireless charging device P, while the receiving coil 262 is provided in the cover 54 of the seat cover assembly 5. When the cover 54 is in the closed state relative to the seat 52, the portable wireless charging device P can be put on the cover 54, making the receiving coil 262 and the transmitting coil 256 close to each other to generate induced current, which charges the rechargeable battery 22 as shown in FIG. 9.

As shown in FIG. 3, the power transmission module 25 includes a current detector 257, a voltage amplifier 258, and a rectifier filter 259. The direct current which passes through the transmitting coil 256 will pass through the current detector 257 in parallel, and then pass through the voltage amplifier 258, and the rectifier filter 259 sequentially, and finally, a transmission voltage value 251 is obtained. In this embodiment, the transmission voltage value 251 will be compared with a reference voltage value 250 to determine whether the direct current power supply device 20 is going to charge the rechargeable battery 22.

If the transmission voltage value 251 is greater than the reference voltage value 250, the rechargeable battery 22 is being charged. On the other hand, if the transmission voltage value 251 is less than or equal to the reference voltage value 250, the rechargeable battery 22 has been charged, or, there is no electromagnetic induction between the receiving coil 262 and the transmitting coil 256. In this embodiment, if the transmission voltage value 251 is less than or equal to the reference voltage value 250, the power transmission module 25 automatically cuts off the current.

In this embodiment, the power transmission module 25 includes a pilot light (not shown). If the transmission voltage value 251 is greater than the reference voltage value 250, the pilot light shows a first light signal. By contrast, if the transmission voltage value 251 is less than or equal to the reference voltage value 250, the pilot light shows a second light signal which is different from the first light signal. For example, the first light signal can be flashing red light representing the rechargeable battery 22 is being charged, while the second light signal can be constant green light representing the rechargeable battery 22 has been charged. Practically, the pilot light is able to show a third light signal. For example, if there is no electromagnetic induction between the receiving coil 262 and the transmitting coil 256, that is, if the rechargeable battery 22 has not been charged, the third light signal can be constant yellow light.

As shown in FIG. 4, the electric assembly 14 includes a seat heater 140, a dryer 141, a pivoting assembly 142, a manual controller 143, a remote receiver 144, a sterilization member 145, a deodorizing member 146, an air compressor 147, or a combination of the above. For example, the seat heater 140 includes a cover, a heater, a temperature sensor, a thermal fuse, a human body detector, and the seat, wherein the main function of the seat heater 140 is to heat the seat 52. The human body detector is provided to ensure that a wash switch will not be activated before it detects a user is seated on the seat, which can avoid the danger of continuous heating and excessive high temperature seat caused by wrongly pressing the switch. The dryer 141 is mainly composed of a blower, a heater, a temperature sensor and an air duct cover; the main function of the dryer 141 is to keep the toilet seat cover dry to prevent germs and mold from breeding through electrifying the heater, and with hot air generated by the blower. The pivoting assembly 142 is provided at the pivot of the cover 54 and the seat 52 to control the cover 54 to be in the lifted state or the closed state relative to the seat 52 with electric control method. The manual controller 143 consists of buttons and status displaying LEDs, and users can select operation mode according to their needs, such as start-up, hip washing, or female intimate part cleaning. The remote receiver 144 can cooperate with a remote control to provide remote monitoring function, such as seat pre-warming and disinfection. The sterilization member 145 includes a UV LED light to sterilize the seat. The deodorizing member 146 mainly consists of air purification materials (e.g., activated carbon and cold catalyst) and a draught fan so as to eliminate the odor after the toilet is used by the purification materials, and to provide an odorless toilet. The air compressor 147 is provided mainly for compressing air to control a shifting valve element 164 to shift washing functions provided by a washing device 16 to users, such as hip washing, female intimate part cleaning, or automatic disinfection and cleaning to a wash assembly 165.

As shown in FIG. 4, the wireless power supply and electric control system for a toilet seat cover 1 includes the washing device 16 which is provided in the seat 52. The washing device 16 includes a pressure regulator assembly 161, a flowmeter 162, an instant thermal assembly 163, the shifting valve element 164, and the wash assembly 165. The shifting valve element 164 is provided to shift washing functions provided by the washing device 16 to users.

In this embodiment, the pressure regulator assembly 161 includes a connector, an electromagnetic valve, and a pressure regulator. The connector is provided to connect a water inlet pipe and the pressure regulator; the electromagnetic valve is provided to control the water flow in the washing device; the pressure regulator is provided to keep the water output pressure in the washing device stable.

In this embodiment, the flowmeter 162 is provided to monitor the water flow in the washing device 16, and transmit the monitoring results to the electric control unit 12. According to the monitoring results, the electric control unit 12 controls the instant thermal assembly 163 to heat the water in the washing device 16.

In this embodiment, the instant thermal assembly 163 includes a heater, a temperature control switch, a temperature sensor, and a water level switch. The heater heats the water in the washing device 16 to make the water reach a preset temperature, while the temperature control switch controls the temperature of the water in the washing device 16. The temperature sensor monitors the temperature of the water in the washing device 16, and sends it to the electric control unit 12; the electric control unit 12 controls the temperature control switch and the heater to turn on or turn off. If the water temperature is higher than the preset temperature, the temperature control switch blocks the power to the heater, and the water level switch is provided to avoid the heater from dry heating. In this embodiment, the heater is a positive temperature coefficient (PTC) thermistor heater.

In this embodiment, the instant thermal assembly 163 includes an instant thermal control board 160 which is provided to control the heating time and power of the heater to the water in the washing device 16, as well as to control the temperature of the water in the washing device 16. Specifically, the temperature sensor collects water temperature data in the washing device 16 and sends control signal to the instant thermal control board 160, and then the instant thermal control board 160 controls a heating pipe to make the water in the washing device 16 reach the preset temperature.

In this embodiment, the wash assembly 165 includes a motor, a gear train, and a nozzle group. The motor drives the gear train which meshes with racks in the nozzle group to make the nozzle group controllably move back and forth. The water in the washing device 16 is sprayed out by the nozzle group for providing users a wash function. The motor is electrically connected to the direct current power supply device 20 and the electric control unit 12 which controls the operation of the motor.

By the abovementioned design, the wireless power supply and electric control system for a toilet seat cover uses the direct current power supply device to supply power to the electric device of the toilet seat cover directly rather than using an exposed plug or external wire, which could let users get an electric shock. Besides, using the rechargeable battery as the resource of direct current for the direct current power supply device makes the toilet seat cover beautiful and clean, which improves the quality and brings the toilet seat cover a sense of design.

The embodiments described above are only preferred embodiments of the present invention. All equivalent structures which employ the concepts disclosed in this specification and the appended claims should fall within the scope of the present invention.

What is claimed is:

1. A wireless power supply and electric control system for a toilet seat cover comprising:
a seat cover assembly comprising a seat and a cover which is controllable to move pivotally relative to the seat so that the cover is in a closed state or a lifted state relative to the seat, wherein when the cover is in the closed state relative to the seat, the cover covers the seat, while when the cover is in the lifted state relative to the seat, the cover doesn't cover the seat so that the seat is exposed;
an electric device which is provided in the seat cover assembly, wherein the electric device comprises an electric control unit and at least an electric assembly; the electric control unit transmits an electrical control signal to the at least an electric assembly to actuate the at least an electric assembly; and
a direct current power supply device which is provided in the seat cover assembly and is electrically connected to the electric device, wherein the direct current power supply device comprises at least a rechargeable battery which supplies power to the electric device for operation.

2. The wireless power supply and electric control system of claim 1, wherein the at least a rechargeable battery is fixed in the seat cover assembly.

3. The wireless power supply and electric control system of claim 1, wherein the at least a rechargeable battery is detachably provided in the seat cover assembly.

4. The wireless power supply and electric control system of claim 2, wherein the seat cover assembly comprises a cover main body, and the at least a rechargeable battery is fixed in or detachably provided in the cover main body.

5. The wireless power supply and electric control system of claim 3, wherein the seat cover assembly comprises a cover main body, and the at least a rechargeable battery is fixed in or detachably provided in the cover main body.

6. The wireless power supply and electric control system of claim 4, wherein the cover main body comprises a battery compartment for accommodating the at least a rechargeable battery so that the at least a rechargeable battery can be detachably installed in the battery compartment.

7. The wireless power supply and electric control system of claim 5, wherein the cover main body comprises a battery compartment for accommodating the at least a rechargeable battery so that the at least a rechargeable battery can be detachably installed in the battery compartment.

8. The wireless power supply and electric control system of claim 6, wherein the battery compartment has a drainage groove provided around a top edge of the battery compartment to prevent water from entering the battery compartment.

9. The wireless power supply and electric control system of claim 7, wherein the battery compartment has a drainage groove provided around a top edge of the battery compartment to prevent water from entering the battery compartment.

10. The wireless power supply and electric control system of claim 6, wherein the at least a rechargeable battery comprises a waterproof ring provided around an outer surface of the at least a rechargeable battery; when the at least a rechargeable battery is installed in the battery compartment, the waterproof ring is sandwiched between the outer surface of the at least a rechargeable battery and an inner wall of the battery compartment.

11. The wireless power supply and electric control system of claim 7, wherein the at least a rechargeable battery comprises a waterproof ring provided around an outer surface of the at least a rechargeable battery; when the at least a rechargeable battery is installed in the battery compartment, the waterproof ring is sandwiched between the outer surface of the at least a rechargeable battery and an inner wall of the battery compartment.

12. The wireless power supply and electric control system of claim 1, wherein the direct current power supply device comprises a wireless charging member which comprises a power transmission module and a power receiving module; the power transmission module and the power receiving module are connected through electromagnetic signal; when the power transmission module is electrically connected to an exterior power source, the power transmission module transmits an electromagnetic signal to the power receiving module; the power receiving module is electrically connected to the at least a rechargeable battery for charging the at least a rechargeable battery.

13. The wireless power supply and electric control system of claim 12, wherein the power transmission module comprises a current pulse generator, a power amplifier, and a transmitting coil; during the exterior power source supplies a direct current to the power transmission module, the direct current passes through the current pulse generator, the power amplifier, and the transmitting coil in sequence, which makes the transmitting coil generate a magnetic field; the power receiving module comprises a receiving coil and a rectifier filter; when the transmitting coil generates the magnetic field, and when the receiving coil approaches the transmitting coil, the receiving coil generates an induced current which passes through the rectifier filter and then supplies power to the at least a rechargeable battery.

14. The wireless power supply and electric control system of claim 13, wherein power transmission module comprises a current detector, a voltage amplifier, and a rectifier filter; the direct current which passes through the transmitting coil passes through the current detector in parallel, and then passes through the voltage amplifier and the rectifier filter sequentially, and finally a transmission voltage value is obtained; if the transmission voltage value is greater than a reference voltage value, the at least a rechargeable battery is being charged; if the transmission voltage value is less than or equal to the reference voltage value, the at least a rechargeable battery has been charged, or, there is no electromagnetic induction between the receiving coil and the transmitting coil.

15. The wireless power supply and electric control system of claim 14, wherein if the transmission voltage value is less than or equal to the reference voltage value, the power transmission module automatically cuts off current.

16. The wireless power supply and electric control system of claim 14, wherein the power transmission module comprises a pilot light; if the transmission voltage value is greater than the reference voltage value, the pilot light shows a first light signal; if the transmission voltage value is less than or equal to the reference voltage value, the pilot light shows a second light signal which is different from the first light signal.

17. The wireless power supply and electric control system of claim 13, wherein the transmitting coil is provided in a wall, while the receiving coil is provided in the cover of the seat cover assembly; when the cover is in the lifted state relative to the seat, the receiving coil and the transmitting coil are close to each other, which makes the receiving coil generate the induced current to charge the at least a rechargeable battery.

18. The wireless power supply and electric control system of claim 13, wherein the transmitting coil is provided in a portable wireless charging device, while the receiving coil is provided in the cover of the seat cover assembly; when the cover is in the closed state relative to the seat, the portable wireless charging device can be put on the cover, making the receiving coil and the transmitting coil close to each other to generate the induced current, which charges the at least a rechargeable battery.

19. The wireless power supply and electric control system of claim 1, wherein the direct current power supply device comprises a power distribution unit which is electrically connected to the electric control unit and the at least an electric assembly of the electric device for supplying direct current to the electric control unit and the at least an electric assembly.
